(19) United States
(12) Patent Application Publication
(10) Pub. No.: US 2022/0215679 A1
(43) Pub. Date: Jul. 7, 2022

(54) METHOD OF DETERMINING A DENSITY OF CELLS IN A CELL IMAGE, ELECTRONIC DEVICE, AND STORAGE MEDIUM

(71) Applicant: HON HAI PRECISION INDUSTRY CO., LTD., New Taipei (TW)

(72) Inventors: WAN-JHEN LEE, New Taipei (TW); CHIH-TE LU, New Taipei (TW); CHIN-PIN KUO, New Taipei (TW)

(21) Appl. No.: 17/545,396

(22) Filed: Dec. 8, 2021

(30) Foreign Application Priority Data
Jan. 4, 2021 (CN) 202110004116.2

(51) Int. Cl. G06V 20/69; G06V 10/82; G06V 10/774

(52) U.S. Cl. CPC G06V 20/698; G06V 10/774; G06V 10/82; G06V 20/695

(57) ABSTRACT

A method of determining a density of cells in a cell image, an electronic device and a storage medium are disclosed. The method acquires a cell image and extracts mapped features of the cell image by an autoencoder. The mapped features are inputted into a neural network classifier to obtain a feature category and a density range corresponding to the feature category is obtained. The density range is output. The present disclosure can improve n efficiency of obtaining a density of cells in a cell image.

### FIELD

The present disclosure relates to a technical field of image processing, specifically a method of determining a density of cells in a cell image, an electronic device and a storage medium.

### BACKGROUND

By calculating the number and sizes of cells shown in a cell image, the density of cells can be calculated or estimated. However, known methods of calculating the number and sizes of cells in the cell image may have lower efficiencies.

Rapidly obtaining a density of cells in a cell image is problematic.

### BRIEF DESCRIPTION OF THE DRAWINGS

FIG. 1 shows a flowchart of a method of determining a density of cells in a cell image provided in an embodiment of the present disclosure.

FIG. 2 shows a schematic structural diagram of a device of determining a density of cells in a cell image provided in an embodiment of the present disclosure.

FIG. 3 shows a schematic structural diagram of an electronic device in one embodiment of the present disclosure.

### DETAILED DESCRIPTION

The accompanying drawings combined with the detailed description illustrate the embodiments of the present disclosure hereinafter. It is noted that embodiments of the present disclosure and mapped features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

Optionally, the method of determining a density of cells in a cell image of the present disclosure can be applied to one or more electronic devices. Such electronic device includes hardware such as, but not limited to, a microprocessor and an Application Specific Integrated Circuit (ASIC), Field-Programmable Gate Array (FPGA), Digital Signal Processor (DSP), embedded devices, etc.

The electronic device may be a device such as a desktop computer, a notebook, a palmtop computer, or a cloud server. The electronic device can interact with users through a keyboard, a mouse, a remote control, a touch panel, or a voice control device.

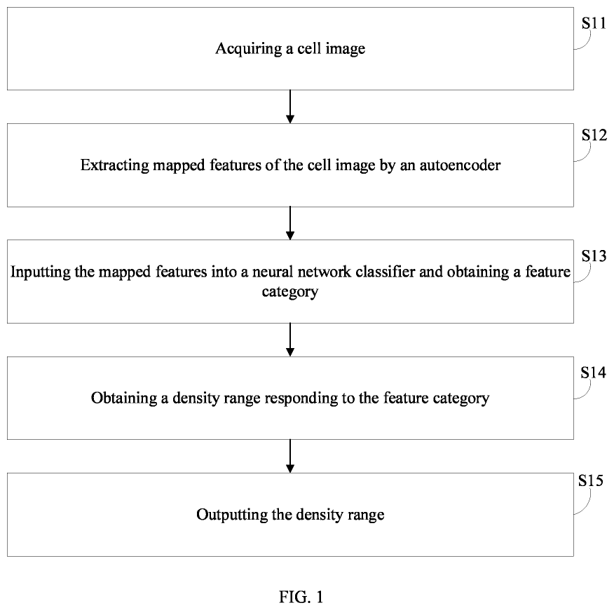

FIG. 1 is a flowchart of a method of determining a density of cells in a cell image in an embodiment of the present disclosure. The method of determining a density of cells in a cell image is applied to an electronic device. According to different needs, the order of the steps in the flowchart can be changed, and some can be omitted.

In block S11, acquiring a cell image.

The cell image refers to an image of cells that needs to be analyzed regarding a density of the cells shown in the cell image. That is to say, the density of the cells in the cell image is unknown. The cell image may include, but is not limited to, cells, red blood cells, other cells, and some impurities. The cells and the red blood cells are the relevant cells.

In some embodiments, before acquiring the cell image, the method includes training an autoencoder. The autoencoder is used to extract and map features of the cell image.

In some embodiments, a process of training the autoencoder includes acquiring a plurality of sample images; inputting the plurality of sample images into a preset neural network; training the preset neural network and obtaining the autoencoder.

The plurality of sample images are images of different categories and different densities of cells which are pre-collected as the training data set for training the autoencoder. The plurality of sample images includes a plurality of groups of the sample images, and densities of cells of the sample images in the same group belong to the same density range, and densities of cells of the sample images in different groups belong to different density ranges.

The sample images can be high-resolution digital images acquired by scanning and recording with a fully automatic microscope or an optical magnification system.

Each sample image is labeled with a density of cells, sample images in the same group correspond to the same feature category. The plurality of sample images and the corresponding densities of cells are used as a data set. Based on the data set, the autoencoder is trained, so that the autoencoder learns features of densities of cells. After the training is completed, a new cell image is input into the autoencoder, and the autoencoder can extract and map features of the new cell image.

After training the autoencoder, its weighting is fixed to ensure that the mapped features will be within a certain distribution range and fall in the same latent space. The mapped features of the sample images with similar density of cells will be distributed with less variation. The mapped features of the sample images with different density of cells will be distributed with greater variation. The mapped features then generated by the autoencoder is input to a back-end neural network classifier.

In some embodiments, before acquiring the cell image, the method also includes training a neural network classifier. The neural network classifier is used to output a particular feature category based on the input of the mapped features.

In some embodiments, a process of training the neural network classifier includes inputting the plurality of groups of the sample images into the autoencoder to obtain mapped features corresponding to each group of the sample images; determining features distribution of all the mapped features in different density ranges according to the mapped features corresponding to the plurality of groups of the sample images and the density ranges corresponding to the plurality of groups of the sample images; obtaining an initial classifier; applying the features distribution to train the initial classifier and obtaining the neural network classifier.

After obtaining the features distribution in different density ranges, the initial classifier can be trained using the features distribution, so that the classifier can classify the mapped features to obtain the feature category. Different cell density categories correspond to different density ranges. Therefore, the obtained cell density categories can be used to determine the corresponding density range.

Distribution of density of cells can be used to estimate a number of cells in a region. If the density is high, the number is high, and if the density is low, the number is less. A general neural network as a classifier requires positive samples and negative samples as training data sets. However, defining the positive samples and the negative samples is a problem. In the embodiment of the present disclosure, only positive samples that need to be used as a training set are used to perform feature extraction, and the density is distinguishable, to determine whether the cells are growing. Not only can the cost of labeling and collecting negative samples be reduced, but the distribution density of cells can be obtained without calculating the actual number, and the proportion of cells can be obtained logically.

In block S12, extracting mapped features of the cell image by an autoencoder.

The mapped features describe the feature information of the density of cells in the cell image in the latent space.

The autoencoder (AE) may be an unsupervised neural network model, which can learn hidden features of the input data, which is called coding. At the same time, the original input data can be reconstructed with the learned hidden feature, which is called decoding. The autoencoder can be used for feature dimensionality reduction, and it can also extract more distinctive feature.

In block S13, inputting the mapped features into a neural network classifier and obtaining a feature category.

The neural network classifier includes a fully connected layer and a SoftMax layer. The fully connected layer and the SoftMax layer are used to let the neural network classifier automatically learn how to classify according to the mapped features. The fully connected layer calculates probability values of the type to which it belongs, according to the mapped features of the cell image. The SoftMax layer outputs a feature category.

The output of the autoencoder is the input into the fully connected layer, and the output of the fully connected layer is the input into the SoftMax layer.

The fully connected layer (FC) is used to map information as to characteristics to a sample mark space, that is, to integrate the characteristics information into a numerical value. As regards the SoftMax layer (normalization layer), for example, if there are one hundred categories of pictures, the output of the normalization layer is a one-hundred-dimensional vector. The sum of all element values in the vector is 1. Each element value in the vector represents a probability value of the picture belonging to the corresponding class. For example, a first value in the vector is a probability value of the picture belonging to a first category, a second value in the vector is a probability value of the picture belonging to a second category, and so on.

The feature category may be a preset character, such as a letter, a character string, a combination of numbers, etc., as a unique identification of one category.

In block S14, obtaining a density range responding to the feature category.

Different categories of density of cells correspond to different density ranges.

In block S15, outputting the density range.

The density ranges can be, for example, 10%-20%, 40%-50%, 70%-80%.

For example, probability values calculated by the fully connected layer are 0.2, 0.7, 0.05, and 0.05, and a classification output from the SoftMax layer is 0, 1, 0, 0. A category corresponding to a numerical value “1” is the feature category and the density range corresponding to the feature category is 60%-80%.

The method provided by the embodiments of the present disclosure uses an autoencoder to extract mapped features of the cell image, ensuring that the extracted features fall within a limited distribution range, and the images of the same category but with different densities of cells have slightly different mapped features, these will fall within the same density range. Thus, a certain distribution range to represent different densities can be found, to distinguish between different densities of cells in the image. The neural network classifier is then used to determine the feature category, and then the density range corresponding to the feature category can be determined. This replaces the traditional classifier's extended time-consumption and lack of robustness, classifying the image more accurately and knowing its density range.

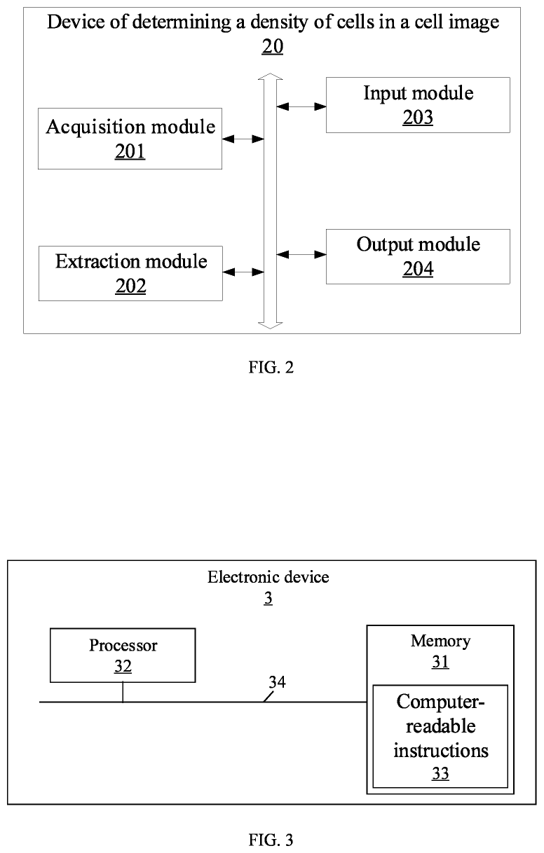

FIG. 2 shows a schematic structural diagram of a device of determining a density of cells in a cell image provided in the embodiment of the present disclosure.

In some embodiments, the device of determining a density of cells in a cell image 20 runs in an electronic device. The device of determining a density of cells in a cell image 20 can include a plurality of function modules consisting of program code segments. The program code of each program code segments in the device of determining a density of cells in a cell image 20 can be stored in a memory and executed by at least one processor to perform image processing (described in detail in FIG. 2).

As shown in FIG. 2, the device of determining a density of cells in a cell image 20 can include: an acquisition module 201, an extraction module 202, an input module 203, and an output module 204. A module as referred to in the present disclosure refers to a series of computer-readable instruction segments that can be executed by at least one processor and that are capable of performing fixed functions, which are stored in a memory. In some embodiment, the functions of each module will be detailed.

The above-mentioned integrated unit implemented in a form of software functional modules can be stored in a non-transitory readable storage medium. The above software function modules are stored in a storage medium and includes several instructions for causing an electronic device (which can be a personal computer, a dual-screen device, or a network device) or a processor to execute the method described in various embodiments in the present disclosure.

The acquisition module 201 acquires a cell image.

The cell image refers to an image of cells that needs to be analyzed regarding a density of the cells shown in the cell image. That is to say, the density of the cells in the cell image is unknown. The cell image may include, but is not limited to, cells, red blood cells, other cells, and some impurities. The cells and the red blood cells are the relevant cells.

In some embodiments, before acquiring the cell image, the device trains an autoencoder. The autoencoder is used to extract and map features of the cell image.

In some embodiments, a process of training the autoencoder includes acquiring a plurality of sample images; inputting the plurality of sample images into a preset neural network; training the preset neural network and obtaining the autoencoder.

The plurality of sample images are images of different categories and different densities of cells which are pre-collected as the training data set for training the autoencoder. The plurality of sample images includes a plurality of groups of the sample images, and densities of cells of the sample images in the same group belong to the same density range, and densities of cells of the sample images in different groups belong to different density ranges.

The sample images can be high-resolution digital images acquired by scanning and recording with a fully automatic microscope or an optical magnification system.

Each sample image is labeled with a density of cells, sample images in the same group correspond to the same feature category. The plurality of sample images and the corresponding densities of cells are used as a data set. Based on the data set, the autoencoder is trained, so that the autoencoder learns features of densities of cells. After the training is completed, a new cell image is input into the autoencoder, and the autoencoder can extract and map features of the new cell image.

After training the autoencoder, its weighting is fixed to ensure that the mapped features will be within a certain distribution range and fall in the same latent space. The mapped features of the sample images with similar density of cells will be distributed with less variation. The mapped features of the sample images with different density of cells will be distributed with greater variation. The mapped features then generated by the autoencoder is input to a back-end neural network classifier.

In some embodiments, before acquiring the cell image, the method also includes training a neural network classifier. The neural network classifier is used to output a particular feature category based on the input of the mapped features.

In some embodiments, a process of training the neural network classifier includes inputting the plurality of groups of the sample images into the autoencoder to obtain mapped features corresponding to each group of the sample images; determining features distribution of all the mapped features in different density ranges according to the mapped features corresponding to the plurality of groups of the sample images and the density ranges corresponding to the plurality of groups of the sample images; obtaining an initial classifier; applying the features distribution to train the initial classifier and obtaining the neural network classifier.

After obtaining the features distribution in different density ranges, the initial classifier can be trained using the features distribution, so that the classifier can classify the mapped features to obtain the feature category. Different cell density categories correspond to different density ranges. Therefore, the obtained cell density categories can be used to determine the corresponding density range.

Distribution of density of cells can be used to estimate a number of cells in a region. If the density is high, the number is high, and if the density is low, the number is less. A general neural network as a classifier requires positive samples and negative samples as training data sets. However, defining the positive samples and the negative samples is a problem. In the embodiment of the present disclosure, only positive samples that need to be used as a training set are used to perform feature extraction, and the density is distinguishable, to determine whether the cells are growing. Not only can the cost of labeling and collecting negative samples be reduced, but the distribution density of cells can be obtained without calculating the actual number, and the proportion of cells can be obtained logically.

The extraction module 202 extracts mapped features of the cell image by an autoencoder.

The mapped features describe the feature information of the density of cells in the cell image in the latent space.

The autoencoder (AE) may be an unsupervised neural network model, which can learn hidden features of the input data, which is called coding. At the same time, the original input data can be reconstructed with the learned hidden feature, which is called decoding. The autoencoder can be used for feature dimensionality reduction, and it can also extract more distinctive feature.

The input module 203 inputs the mapped features into a neural network classifier and obtains a feature category.

The neural network classifier includes a fully connected layer and a SoftMax layer. The fully connected layer and the SoftMax layer are used to let the neural network classifier automatically learn how to classify according to the mapped features. The fully connected layer calculates probability values of the type to which it belongs, according to the mapped features of the cell image. The SoftMax layer outputs a feature category.

The output of the autoencoder is the input into the fully connected layer, and the output of the fully connected layer is the input into the SoftMax layer.

The fully connected layer (FC) is used to map information as to characteristics to a sample mark space, that is, to integrate the characteristics information into a numerical value. As regards the SoftMax layer (normalization layer), for example, if there are one hundred categories of pictures, the output of the normalization layer is a one-hundred-dimensional vector. The sum of all element values in the vector is 1. Each element value in the vector represents a probability value of the picture belonging to the corresponding class. For example, a first value in the vector is a probability value of the picture belonging to a first category, a second value in the vector is a probability value of the picture belonging to a second category, and so on.

The feature category may be a preset character, such as a letter, a character string, a combination of numbers, etc., as a unique identification of one category.

The acquisition module 201 obtains a density range responding to the feature category.

Different categories of density of cells correspond to different density ranges.

The output module 204 outputs the density range.

The density ranges can be, for example, 10%-20%, 40%-50%, 70%-80%.

For example, probability values calculated by the fully connected layer are 0.2, 0.7, 0.05, and 0.05, and a classification output from the SoftMax layer is 0, 1, 0, 0. A category corresponding to a numerical value “1” is the feature category and the density range corresponding to the feature category is 60%-80%.

The device provided by the embodiments of the present disclosure uses an autoencoder to extract mapped features of the cell image, ensuring that the extracted features fall within a limited distribution range, and the images of the same category but with different densities of cells have slightly different mapped features, these will fall within the same density range. Thus, a certain distribution range to represent different densities can be found, to distinguish between different densities of cells in the image. The neural network classifier is then used to determine the feature category, and then the density range corresponding to the feature category can be determined. This replaces the traditional classifier's extended time-consumption and lack of robustness, classifying the image more accurately and knowing its density range.

The embodiment also provides a non-transitory readable storage medium having computer-readable instructions stored therein. The computer-readable instructions are executed by a processor to implement the steps in the above-mentioned image processing method, such as in steps in blocks S11-S15 shown in FIG. 1:

In block S11, acquiring a cell image;

In block S12, extracting mapped features of the cell image by an autoencoder;

In block S13, inputting the mapped features into a neural network classifier and obtaining a feature category;

In block S14, obtaining a density range responding to the feature category;

In block S15, outputting the density range.

The computer-readable instructions are executed by the processor to realize the functions of each module/unit in the above-mentioned device embodiments, such as the modules 201-204 in FIG. 2:

The acquisition module 201 acquires a cell image;

The extraction module 202 extracts mapped features of the cell image by an autoencoder;

The input module 203 inputs the mapped features into a neural network classifier and obtains a feature category;

The acquisition module 201 obtains a density range responding to the feature category;

The output module 204 outputs the density range.

FIG. 3 is a schematic structural diagram of an electronic device provided in an embodiment of the present disclosure. The electronic device 3 may include: a memory 31, at least one processor 32, computer-readable instructions 33 stored in the memory 31 and executable on the at least one processor 32, for example, determining a density of cells in a cell image programs, and at least one communication bus 34. The processor 32 executes the computer-readable instructions 33 to implement the steps in the embodiment of the method of determining a density of cells in a cell image, such as in steps in block S11-S15 shown in FIG. 1. Alternatively, the processor 32 executes the computer-readable instructions 33 to implement the functions of the modules/units in the foregoing device embodiments, such as the modules 201-204 in FIG. 2.

For example, the computer-readable instructions 33 can be divided into one or more modules/units, and the one or more modules/units are stored in the memory 31 and executed by the at least one processor 32. The one or more modules/units can be a series of computer-readable instruction segments capable of performing specific functions, and the instruction segments are used to describe execution processes of the computer-readable instructions 33 in the electronic device 3. For example, the computer-readable instruction can be divided into the acquisition module 201, the extraction module 202, the input module 203, and the output module 204 as in FIG. 2.

The electronic device 3 can be an electronic device such as a desktop computer, a notebook, a palmtop computer, and a cloud server. Those skilled in the art will understand that the schematic diagram 3 is only an example of the electronic device 3 and does not constitute a limitation on the electronic device 3. Another electronic device 3 may include more or fewer components than shown in the figures or may combine some components or have different components. For example, the electronic device 3 may further include an input/output device, a network access device, a bus, and the like.

The at least one processor 32 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 32 can be a microprocessor or any conventional processor. The processor 32 is a control center of the electronic device 3 and connects various parts of the entire electronic device 3 by using various interfaces and lines.

The memory 31 can be configured to store the computer-readable instructions 33 and/or modules/units. The processor 32 may run or execute the computer-readable instructions 33 and/or modules/units stored in the memory 31 and may call up data stored in the memory 31 to implement various functions of the electronic device 3. The memory 31 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the electronic device 3. In addition, the memory 31 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

When the modules/units integrated into the electronic device 3 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions 33. The computer-readable instructions 33 can be stored in a non-transitory readable storage medium. The computer-readable instructions 33, when executed by the processor, may implement the steps of the foregoing method embodiments. The computer-readable instructions 33 include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

In the several embodiments provided in the preset application, the disclosed electronic device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit, or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical mapped features can be equivalently substituted, and that these modifications or substitutions are not to detract from the essence of the technical solutions or from the scope of the technical solutions of the embodiments of the present disclosure.

What is claimed is:

1. A method of determining a density of cells in a cell image, the method comprising:
acquiring a cell image;
extracting mapped features of the cell image by an autoencoder;
inputting the mapped features into a neural network classifier and obtaining a feature category;
obtaining a density range responding to the feature category; and
outputting the density range.

2. The method according to claim 1, a process of training the autoencoder comprising:
acquiring a plurality of sample images;
inputting the plurality of sample images into a preset neural network;
training the preset neural network and obtaining the autoencoder.

3. The method according to claim 2, wherein the plurality of sample images comprises a plurality of groups of the sample images, and densities of cells of the sample images in the same group belong to the same density range, and densities of cells of the sample images in different groups belong to different density ranges.

4. The method according to claim 3, a process of training the neural network classifier comprising:
inputting the plurality of groups of the sample images into the autoencoder to obtain mapped features corresponding to each group of the sample images;
determining features distribution of all the mapped features in different density ranges according to the mapped features corresponding to each group of the sample images and the density ranges corresponding to the plurality of groups of the sample images;
obtaining an initial classifier; and
applying the features distribution to train the initial classifier and obtaining the neural network classifier.

5. The method according to claim 4, wherein the neural network classifier comprises a fully connected layer and a SoftMax layer.

6. The method according to claim 5, wherein the fully connected layer calculates probability values of the type to which it belongs, according to the mapped features of the cell image, the SoftMax layer outputs the feature category.

7. The method according to claim 2, wherein the mapped features of the sample images with similar density of cells are distributed with less variation, the mapped features of the sample images with different density of cells are distributed with greater variation.

8. An electronic device comprising a memory and a processor, the memory stores at least one computer-readable instruction, which when executed by the processor causes the processor to:
acquire a cell image;
extract mapped features of the cell image by an autoencoder;
input the mapped features into a neural network classifier and obtain a feature category;
obtain a density range responding to the feature category; and
output the density range.

9. The electronic device according to claim 8, wherein a process of training the autoencoder comprises:
acquiring a plurality of sample images;
inputting the plurality of sample images into a preset neural network;
training the preset neural network and obtaining the autoencoder.

10. The electronic device according to claim 9, wherein the plurality of sample images comprises a plurality of groups of the sample images, and densities of cells of the sample images in the same group belong to the same density range, and densities of cells of the sample images in different groups belong to different density ranges.

11. The electronic device according to claim 10, wherein a process of training the neural network classifier comprises:
inputting the plurality of groups of the sample images into the autoencoder to obtain mapped features corresponding to each group of the sample images;
determining features distribution of all the mapped features in different density ranges according to the mapped features corresponding to each group of the sample images and the density ranges corresponding to the plurality of groups of the sample images;
obtaining an initial classifier; and
applying the features distribution to train the initial classifier and obtaining the neural network classifier.

12. The electronic device according to claim 11, wherein the neural network classifier comprises a fully connected layer and a SoftMax layer.

13. The electronic device according to claim 12, wherein the fully connected layer calculates probability values of the type to which it belongs, according to the mapped features of the cell image, the SoftMax layer outputs the feature category.

14. The electronic device according to claim 9, wherein the mapped features of the sample images with similar density of cells are distributed with less variation, the mapped features of the sample images with different density of cells are distributed with greater variation.

15. A non-transitory storage medium having stored thereon at least one computer-readable instructions that, when the at least one computer-readable instructions are executed by a processor to implement a method of determining a density of cells in a cell image, which comprises:
acquiring a cell image;
extracting mapped features of the cell image by an autoencoder;
inputting the mapped features into a neural network classifier and obtaining a feature category;
obtaining a density range responding to the feature category; and
outputting the density range.

16. The non-transitory storage medium according to claim 15, wherein a process of training the autoencoder comprises:
acquiring a plurality of sample images;
inputting the plurality of sample images into a preset neural network;
training the preset neural network and obtaining the autoencoder.

17. The non-transitory storage medium according to claim 16, wherein the plurality of sample images comprises a plurality of groups of the sample images, and densities of cells of the sample images in the same group belong to the same density range, and densities of cells of the sample images in different groups belong to different density ranges.

18. The non-transitory storage medium according to claim 17, wherein a process of training the neural network classifier comprises:
inputting the plurality of groups of the sample images into the autoencoder to obtain mapped features corresponding to each group of the sample images;
determining features distribution of all the mapped features in different density ranges according to the mapped features corresponding to each group of the sample images and the density ranges corresponding to the plurality of groups of the sample images;
obtaining an initial classifier; and
applying the features distribution to train the initial classifier and obtaining the neural network classifier.

19. The non-transitory storage medium according to claim 18, wherein the neural network classifier comprises a fully connected layer and a SoftMax layer.

20. The non-transitory storage medium according to claim 19, wherein the fully connected layer calculates probability values of the type to which it belongs, according to the mapped features of the cell image, the SoftMax layer outputs the feature category.
